(19) United States
(12) Patent Application Publication
(10) Pub. No.: US 2022/0070361 A1
(43) Pub. Date: Mar. 3, 2022

(54) A METHOD OF USING A MACHINE-READABLE CODE FOR INSTRUCTING CAMERA FOR DETECTING AND MONITORING OBJECTS

(71) Applicant: Kuvio Automation Oy, JYVÄSKYLÄ (FI)

(72) Inventors: Keijo Möttönen, TAMPERE (FI); Hannu Valkonen, HELSINKI (FI)

(73) Assignee: Kuvio Automation Oy, JYVÄSKYLÄ (FI)

(21) Appl. No.: 17/420,322

(22) PCT Filed: Dec. 19, 2019
(86) PCT No.: PCT/FI2019/050913

§ 371 Date: Jul. 1, 2021

(30) Foreign Application Priority Data
Jan. 2, 2019 (FI) 20195002

(51) Int. Cl. H04N 5/232; G06K 7/14; G06K 7/10

(52) U.S. Cl. CPC H04N 5/23218; G06K 7/10722; G06K 7/1417

(57) ABSTRACT

a method includes capturing image data by at least one camera of a camera system, analysing the image data, detecting a machine readable code including configuration data from the image data, and configuring the camera system on the basis of the configuration data of the machine readable code. The method further relates to a camera system performing the method and to a computer program product.

### TECHNICAL FIELD

The aspects of the disclosed embodiments relate to a method for detecting or monitoring objects by a camera, wherein detecting and or monitoring is performed on the basis of instructions derived from an image comprising a machine-readable code such as a QR code.

The aspects of the disclosed embodiment also relate to a camera system and a computer program product causing an apparatus to carry out the method.

### BACKGROUND

In many environments and cases, there are situations when there is a need to monitor or detect objects by cameras in order to determine, for example, their location, position, environment, condition or absence. Surveillance camera systems, camera systems or separate cameras may be programmed to perform these tasks. The captured images are analysed by a processing unit.

WO2017109801 discloses a coded information reader for reading coded information from an object. The reader comprises two camera assemblies. The first camera assembly is configured to acquire frames and to process the acquired frames to perform: detection of object presence, determination of operating parameters for both camera assemblies, coded information decoding, in case of failure of said coded information decoding, triggering of the second camera assembly to acquire frames and to process the acquired frames to perform coded information decoding with the operating parameters set as determined by the first camera assembly for the second camera assembly.

US20110234829 discloses a non-transitory processor-readable medium, which stores code representing instructions to cause a processor to receive a first image of a visual pattern from a sensor. The visual pattern encodes at least one compression parameter, at least one capture parameter or at least one video analytic parameter to be applied to the sensor. The code represents instructions to cause the processor to apply the at least one compression parameter, the at least one capture parameter or the at least one video analytic parameter to the sensor.

### SUMMARY

Now there has been invented an improved method and technical equipment implementing the method. Various aspects of the disclosed embodiments include a method, a camera system comprising at least one image sensor, and a computer readable medium comprising a computer program stored therein, which are characterized by what is stated in the independent claims. Various embodiments of the present disclosure are disclosed in the dependent claims.

According to a first aspect of the disclosed embodiments, there is provided a method, comprising capturing image data by at least one camera of a camera system;

analysing the image data, detecting a machine readable code comprising configuration data from the image data, and configuring the camera system on the basis of the configuration data of the machine readable code.

According to an embodiment, the configuring data comprises at least one monitoring conditions and the camera system is configured on the basis of at least one monitoring conditions. According to an embodiment, the monitoring conditions includes instructions for configuring the camera system to detect a certain number of machine readable codes in the images. According to an embodiment, the monitoring conditions includes instructions for configuring the camera system to determine a distance between machine readable codes or objects. According to an embodiment, the monitoring conditions includes instructions for configuring the camera system to determine a distance of an object from a certain point or to detect whether an object exists in a space. According to an embodiment, the monitoring conditions includes instructions for configuring the camera system to determine an angle of a movement of an object. According to an embodiment, the monitoring conditions includes instructions for configuring the camera system to determine a range of a movement of an object or to determine a moving direction of an object. According to an embodiment, the monitoring conditions includes instructions for configuring the camera system on the basis of a combination of at least two monitoring conditions. According to an embodiment, the method further comprises notifying a user if monitoring conditions are not fulfilled. According to an embodiment, the method further comprises notifying a user if monitoring conditions are fulfilled. According to an embodiment, the machine readable code comprises a contacting address where to notify when the monitoring conditions are fulfilled or are not fulfilled. According to an embodiment, the machine readable code further indicates for the camera system that there is at least one further machine readable code in a space to be detected or which at least one camera is configured to be used for monitoring the space. According to an embodiment, the machine readable code is a quick response (QR) code.

According to a second aspect of the disclosed embodiments, there is provided a camera system comprising an image sensor and a data processing device, wherein said image sensor is arranged to capture image data by at least one camera of a camera system; analysing the image data; detect a machine readable code comprising configuration data from the image data; and configure the camera system on the basis of the configuration data of the machine readable code.

According to an embodiment, the configuring data comprises at least one monitoring conditions and the camera system is configured on the basis of at least one monitoring conditions. According to an embodiment, the monitoring conditions includes instructions for configuring the camera system to detect a certain number of machine readable codes in the images. According to an embodiment, the monitoring conditions includes instructions for configuring the camera system to determine a distance between machine readable codes or objects. According to an embodiment, the monitoring conditions includes instructions for configuring the camera system to determine a distance of an object from a certain point or to detect whether an object exists in a space. According to an embodiment, the monitoring conditions includes instructions for configuring the camera system to determine an angle of a movement of an object. According to an embodiment, the monitoring conditions includes instructions for configuring the camera system to determine a range of a movement of an object or to determine a moving direction of an object. According to an embodiment, the monitoring conditions includes instructions for configuring the camera system on the basis of a combination of at least two monitoring conditions. According to an embodiment, the machine readable code further comprises instructions for notifying a user if monitoring conditions are not fulfilled or if monitoring conditions are fulfilled. According to an embodiment, the machine readable code further comprises a contacting address where to notify when the monitoring conditions are fulfilled or are not fulfilled. According to an embodiment, the machine readable code further comprises information that there is at least one further machine readable code in a space to be detected. According to an embodiment, the machine readable code further comprises information about which at least one camera is configured to be used for monitoring the space. According to an embodiment, the machine readable code is a quick response (QR) code.

According to a third aspect of the disclosed embodiments, there is provided a computer program product, stored on a computer readable medium and executable in a computing device, wherein the computer program product comprises instructions for a data processing device to: analyse image data captured by at least one camera of a camera system, detect a machine readable code comprising configuration data from the image data, and configure the camera system on the basis of the configuration data of the machine readable code.

### BRIEF DESCRIPTION OF THE DRAWINGS

In the following, various embodiments of the present disclosure will be described in more detail with reference to the appended drawings, in which

FIG. 1 shows a camera system according to an example embodiment;

FIG. 2 shows a camera system according to an example embodiment;

FIG. 3 shows a camera system according to an example embodiment;

FIG. 4a-c show a camera system according to an example embodiment; and

FIG. 5 shows a method performed by a camera system according to an example embodiment.

### DETAILED DESCRIPTION

The aspects of the disclosed embodiments relate to a camera system according to an example embodiment and comprising at least one camera and a data processing device. The at least one camera is used for detecting and/or monitoring environment or a space and when a machine-readable code is detected, the camera system is configured on the basis of the instructions i.e. data included in the detected machine-readable code. The machine-readable code may, for example, comprise a reference number, which is interpreted in a camera system as a predefined command and/or a set of configuration parameters. This way only a small amount of QR content is needed and reading of the code is easy. Also, the same machine-readable code can be reused, and the same reference number can trigger a different action once the camera system has been reprogrammed. Alternatively or additionally, the machine-readable code may, for example, comprise a snippet of arbitrary programming code, for example, in JavaScript, which may be run in a camera system. The behaviour of the camera system can be modified by changing the machine-readable code only. No reprogramming of the camera system is needed. Furthermore, the machine-readable code may, for example, comprise an URL link, which points to a WEB address comprising programming code. URL usually comprises only a small amount of characters. In addition, the machine-readable codes comprising an URL link can be reused and the camera system can be programmed remotely. However, the new program must be retrieved from the WEB, so the camera system must be connected to the internet. However, it should be noted that these abovementioned examples are just examples of configuration data included in the detected machine-readable code. It is also possible to use any other suitable method or combinations of methods for configuring a camera system.

The present disclosure further relates to a method according to an example embodiment of the disclosed embodiments, wherein one or more images or video image data is captured by at least one camera of a camera system, the captured image data is analysed, and if a machine-readable code is detected by the camera system, the camera system is configured on the basis of the instructions included in the machine readable code. The configuration includes determining of at least one monitoring conditions for the camera system. After configuration, the camera system continues capturing and analysing the image data as defined in the at least one monitoring conditions of the machine readable code. And if the monitoring conditions are determined to be fulfilled, the camera system may continue capturing and analysing image data of the environment/space. The monitoring conditions may be fulfilled, for example, when monitoring conditions of a machine-readable code has determined allowable conditions, for example, allowable maximum distance, allowable moving direction, allowable moving angle, allowable minimum/maximum numbers of machine-readable codes in a space, etc, and the camera has detected that the imaged situation falls under these conditions. And if the monitoring conditions are analysed to be non-fulfilled, the camera system may, for example, perform an alarm or indicate a user or perform any other action determined by the detected and read machine readable code. The monitoring conditions may be non-fulfilled, for example, when the camera has detected that the imaged situation does not fall under monitoring conditions, for example, conditions mentioned just above. The machine readable code may be attached to an object that is arranged to be monitored.

The term “camera” includes in this context any image sensor suitable for capturing images and/or video i.e. image data, for example, a black and white or colour camera, a regular or smart camera, or any suitable camera. The data processing device may be a separate device, or it may be an integrated part of a camera. The term “object” includes in this context any person or item. The term “machine readable code” includes in this context any code suitable to be imaged and read by a camera and comprising information for configuring and/or instructing at least one camera. Machine readable code may be, for example, a quick response (QR) code that is a form of a two-dimensional bar code that encodes alphanumeric information. The machine readable code may comprise several types of information. For example, the information may comprise data for configuring a camera system. The term “configuring” includes in this context any type of reconfiguring or instructing i.e. programming at least one camera and/or data processing device. The configuration may include determining of allowable monitoring conditions in the image data, for example, determining of an allowable distance between objects, an allowable range of movements, an allowable angle of movement, an allowable moving direction of an object, an allowable number of machine readable codes in a space, etc. The configuration may also include determining of an object to be monitored, or a contact information in a case when allowable conditions are not fulfilled, etc. More examples and more detailed examples are presented below.

As already stated above, a camera system may be configured to perform several different tasks defined by monitoring conditions, wherein the monitoring conditions are determined for the camera system by configuration data of a detected machine-readable code. Monitoring conditions may comprise, for example, the following configuring instructions for the camera system. A camera may be configured to detect a certain number of machine readable codes in the following images, and if the number of detected machine readable codes is too high or small i.e. not allowable according to the monitoring conditions, it may indicate it to a user. Or a camera may be configured to determine a distance between machine readable codes or objects not comprising a machine readable code or between a machine readable code and an object not comprising a machine readable code in the images, and if the distance exceeds or falls below a certain distance i.e. is not allowable according to the monitoring conditions, it may indicate it to a user. Or a camera may be configured to determine a distance of an object from a certain point, for example, a distance between an art piece from a wall, and if the distance is too big or small i.e. not allowable according to the monitoring conditions, it may indicate it to a user. Or a camera may be configured to detect whether an object exists in a space, and if not or yes, depending on what is determined to be allowable by monitoring conditions in the machine readable code, it may indicate it to a user. Or a camera may be configured to determine an angle of a movement of an object, for example, an opening angle of a door i.e. the distance between the edge of the door and the door frame, and if the detected angle (distance) is detected to be too big or small i.e. not allowable according to the monitoring conditions, it may indicate it to a user. Or a camera may be configured to determine a range of a movement of an object, and if the detected moving range is too big or small i.e. not allowable according to the monitoring conditions, it may indicate it to a user. Or the at least one camera may be configured to determine a moving direction of an object, and if the detected moving direction is not allowable according to the monitoring conditions, it may indicate it to a user. It should be noted that is also possible that two or more monitoring conditions are determined for a camera system by one machine readable code. For example, the camera system may be configured to determine a certain number of machine readable codes and a distance between those codes in the following images, and if the number of detected machine readable codes is too high or small and/or the distance between the detected machine readable codes is too big or small i.e. not allowable according to the monitoring conditions, it may indicate it to a user. The two more determined monitoring conditions may be other conditions than the mentioned number and distance. The machine readable code may further or instead of at least one monitoring conditions comprise other information than monitoring conditions information. The machine readable code may further, for example, comprise a contacting information where to notify, or just instructions that a user (contacting information is predetermined for a camera system) has to be notified, when monitoring conditions are not fulfilled, for example, when a number of detected machine readable codes is too high or small, a distance between at least two objects with or without machine readable code exceeds or falls below a certain distance, an object disappears from a space, the detected moving range is too big or small, detected moving angle is detected to be too big or small or the detected moving direction of an object is not correct, or when a camera just detects a machine readable code in a space, etc. or when a monitoring conditions are fulfilled. Or the machine-readable code may, for example, indicate a camera system that there is at least one other machine-readable code to be found and to be read in a space, or it may determine the at least one camera that is configured to be used for detecting the space, etc.

It is also possible that an ultraviolet camera is used in a camera system according to an example embodiment in addition or instead of a non-ultraviolet camera. Then it is possible to use the camera system, for example, for detecting absence or movement of objects even in the dark conditions.

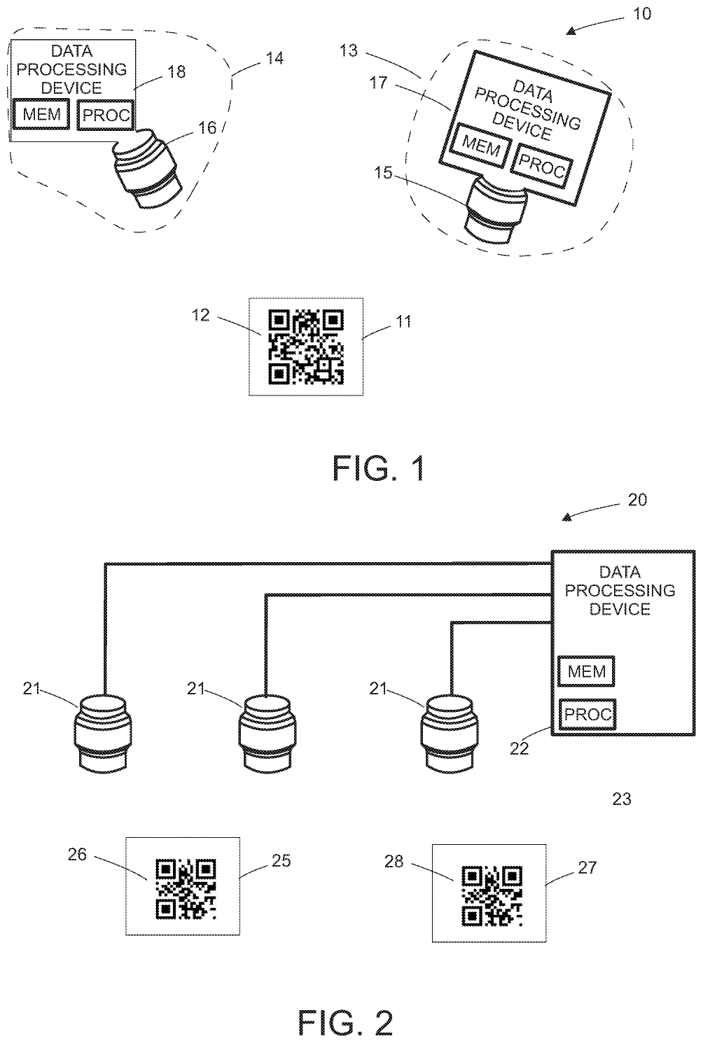

FIG. 1 shows a camera system according to an example embodiment. In this embodiment, a camera system 10 comprising two smart cameras 13, 14 is disclosed in conjunction with an object 11 in a monitoring space. The smart camera 13, 14 comprises an image sensor 15, 16 and a data processing device 17, 18. The object 11 includes a machine readable code 12 and the data included in the code 12 is used for configuring the cameras system 10.

In this embodiment the code 12 is used for configuring the cameras system 10 to monitor the object 11 and if the object 11 does not exists in the image data, the cameras 13, 14 are programmed to indicate a person, whose contact information is included in the code 12. In other words, according to monitoring conditions, there should be at least one code 12 in the captured image data.

It is also possible that there is only one camera or that there are more than two cameras as mentioned in this example, for example, 3-10 or even more. It is further possible, that there are more than one machine readable codes in the monitoring space. And if at least one camera also detects the second machine readable code in addition to the first machine readable code, the camera system may receive further instructions i.e. it is re-configured or further configured on the base of the second machine readable code, but it is also possible that there are two or more similar machine readable codes in the monitoring environment and the camera system is configured only after detecting the first machine readable code.

The data processing device 17, 18 comprises at least one processor, at least one memory including computer program code for one or more program units and means for receiving image data wirelessly or via wired connection from the sensor 15, 16, for example, a receiver or a transceiver, and means for connecting a contact person wirelessly or via wired connection. There may be multiple processors e.g. a general purpose processor and a graphics processor and a DSP processor and/or multiple different memories e.g. volatile memory for storing data and programs at run-time and non-volatile memory such as a hard disk for permanently storing data and programs. The data processing device 17 of the smart camera 14 and the data processing device 18 of the smart camera 14 may be any computing device suitable for handling image data such as a computer. The data processing device 17, 18 is in electronic communication with the image sensor 15, 16 via signal lines respectively. The smart camera 13, 14 may also include a video controller and an audio controller for generating signals that can be produced for the user with computer accessories. The smart camera 13, 14 may produce output to the user through output means. The video controller may be connected to a display (not shown). The display may be e.g. a flat panel display or a projector for producing a larger image. The audio controller may be connected to a sound source, such as loudspeakers or earphones. The smart camera 13, 14 may also include an acoustic sensor such as a microphone.

At least one of the data processing devices 17, 18 is configured to receive image data from the image sensor 15, 16. The at least one of the data processing devices 17, 18 analyses the above-mentioned image data and if it is detected to comprise the machine readable code 12, the camera system 10 is configured on the basis of the data i.e. configuration instructions of the machine readable code 12. And as already mentioned above, at least that data processing device part 17, 18 is configured to monitor the object 11 by analysing image data captured by cameras 13, 14 and notify the user by email if monitoring conditions are not fulfilled i.e. the object cannot be detected from image data captured by at least one camera 13, 14.

FIG. 2 shows an embodiment of the present disclosure, in which a camera system 20 comprising three cameras (image sensors) 21 is disclosed in conjunction with two objects 25, 27 both comprising a QR code, 26, 28. The camera system 20 is used for monitoring a space i.e. monitoring environment, wherein the cameras 21 are. The camera system 20 further comprises at least one data processing device 22. The cameras 21 are arranged to capture video i.e. image data from the environment and to transmit the image data to the data processing device 22. From the image data, the data processing device 22 detects QR codes 26, 28, and reads them. In this embodiment, the QR codes 26, 28 comprise instructions on the basis of what the camera system 20 is configured to detect QR codes 26, 28 in the space, and if the system 20 cannot detect both captured QR codes 26, 28 by using cameras 21, the camera system 20 is configured to send a text message to a user, for example, a guard, wherein the text message number may be predetermined for the system 20 or the information may be included in QR code(s) 26, 28. Thus, the monitoring conditions define that there should be at least two codes 26, 28 in the environment and if not, a text message should be sent.

The data processing device 22 comprises at least one processor, at least one memory including computer program code for one or more program units, and means for receiving image data wirelessly or via wired connection, for example, a receiver or a transceiver, and means for transmitting a notification for a user. There may be multiple processors e.g. a general purpose processor and a graphics processor and a DSP processor and/or multiple different memories e.g. volatile memory for storing data and programs at run-time, and non-volatile memory such as a hard disk for permanently storing data and programs. The data processing device 22 may be any computing device suitable for handling image data, such as a computer. The data processing device 22 is in electronic communication with the cameras 21. For handling the signals to/from the signal lines, the data processing device 22 comprises I/O circuitry. The connection between the cameras 21 and the data processing device 22 are a wired or wireless network. The data processing device 22 may also include a video controller and/or an audio controller for generating signals that can be produced to the user with computer accessories. The video controller may be connected to a display. The display may be e.g. a flat panel display or a projector for producing a larger image. The audio controller may be connected to a sound source, such as loudspeakers or earphones.

Alternatively, in another embodiment, the QR codes 26, 28 may comprise data on the basis of what the camera system 20 is configured to detect QR codes 26, 28 in the space, and if the system 20 detects more than one QR codes 26, 28 by using cameras 21, the camera system 20 is configured to send a text message to a user. In this case, the monitoring conditions define that only one code 26, 28 at the time is allowable in the monitored environment.

The cameras 21 may also be still cameras instead of video cameras. Still cameras may be configured to capture image frames at a predetermined frequency, but it is also possible that a QR code 26, 28 defines the frequency. Further it is possible that at least one camera or all cameras 21 are smart cameras comprising a data processing device as an integrated part, and that cameras 21 are connected using wireless or wired connections.

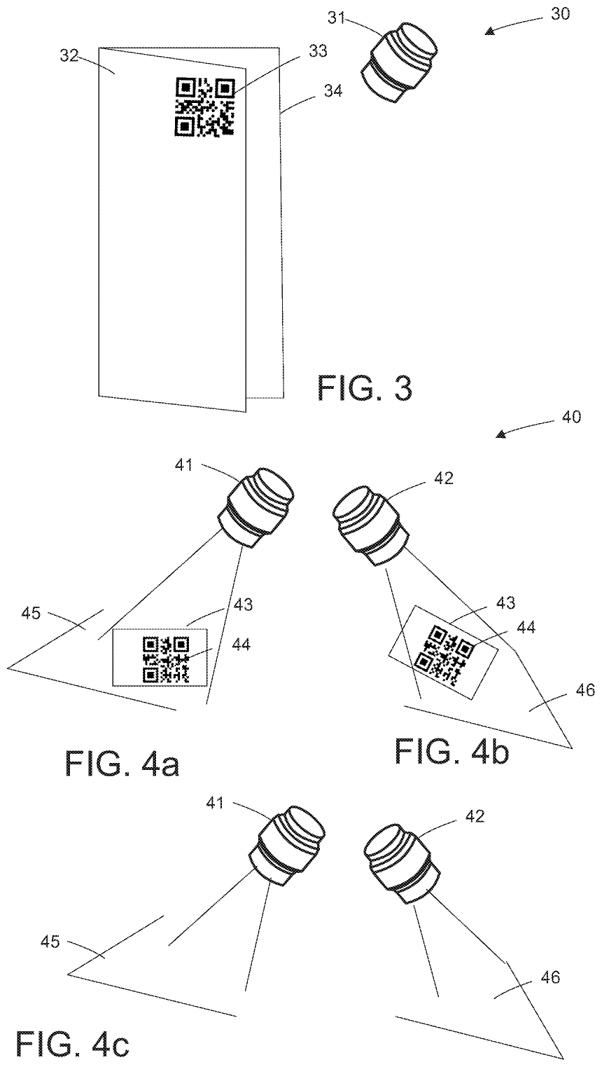

FIG. 3 shows an embodiment of the present disclosure, in which a camera system 30 comprising a camera (image sensor) 31 and suitable data processing means (not shown). There is a door 32 comprising a machine readable code i.e. a QR code 33 in a monitoring environment. The camera system 30 is arranged to monitor the environment by capturing images of the space and to detect the QR code 33 in the image data. The camera system 30 reads the detected QR code 33 and on the base of the data included in the QR code 33, the camera system is configured to monitor the opening angle of the door 32. In this embodiment, the QR code 33 defines for the camera system 30 an allowable opening angle of the door 32 i.e. the distance between the edge of the door 32 and the door frame 34 as a monitoring conditions, and if the detected angle in the following images is detected to be too big or small compared to the allowable opening angle defined by the QR code 33, the camera system 30 is configured to perform an alarm as instructed by the QR code 33.

FIGS. 4a-c show a camera system according to an example embodiment. The camera system 40 comprises two cameras 41, 42 and a data processing device (not shown). Cameras 41, 42 of the camera system 40 are arranged to monitor a monitoring environment by capturing images using their field of views. In FIG. 4a, the first camera 41 in a first part of the monitoring environment 45 captures an image of an object 43 comprising a QR code 44. Data included in the QR code 44 is read by the camera system 40. The code 44 comprises instructions for configuring the camera system 40 to track the object 43, and if at least one of the cameras 41, 42 cannot find the object 43 in the first part of the monitoring environment 45, the camera system is configured to indicate this to a user of the camera system 40. In the FIG. 4b, the first camera 41 cannot find the object 43 anymore, because the object is moved to a second part of the monitoring environment 46 that is out of its field of view. But now the second camera 42 can find the object 43 and there is no need to indicate the user. However, in FIG. 4c none of the cameras 41, 42 can find the object 43 anymore, because it is out of both fields of view and the user is indicated about the situation i.e. about the disappeared object 43. Thus, according to the monitoring conditions, at least one camera 41, 42 should find the object 43 in the monitoring environment.

It should be noted that it is possible that the cameras can move their field of views and the same camera may re-locate i.e. re-find an object even if it is moved, but the principle is still the same as in the example of FIGS. 4a-c, where field of views of cameras are not changing. Also, it is possible that there is only one camera or that there are more cameras than two, for example, 3-10 or even more.

It is also possible that the machine readable code defines a time which is a time period during which monitoring conditions have to be fulfilled and the camera system is configured to indicate only after this period if monitoring conditions are not fulfilled. This period may be called, for example, as a verification period. The verification period may be needed, for example, in a situation, when a number of machine readable codes in a space is determined to be monitored by a camera system, but the objects comprising the codes move a lot and there may also be obstacles or corresponding in the space. Therefore, it is possible that the allowable conditions are fulfilled and there are the adequate number of codes in the space, but cameras cannot find them all the time. Therefore, when the verification period is used, unnecessary alarms may not be made, or messages sent.

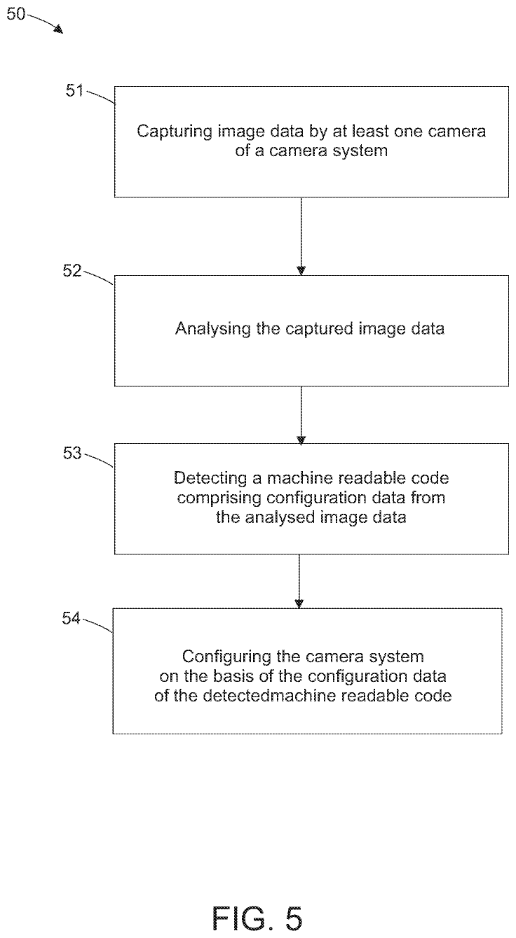

FIG. 5 shows a method 50 performed by a camera system according to an example embodiment. In step 51, image data is captured by at least one camera of the camera system. In step 52, the image data is analysed. In step 53, a machine readable code comprising configuration data is detected from the image data. In step 54, the camera system is configured on the basis of the configuration data of the machine-readable code.

A QR code, may also be used for configuring white balance adjustment of a camera of a camera system. This may be done by arranging at least two known reference colours in the centre area of the QR code. And on the basis of these at least two reference colours white balance adjustment can be performed for cameras and, as a result, after this kind of QR code white balance adjustment different cameras may provide images comprising similar hues. This is advantageous, because when images comprise similar colours, images and things in images can be better compared. A QR code has advantages to be used with white balance adjustment, because it is easy to detect from images and the centre area may be arranged for reference colours. Furthermore, the QR code may comprise information about the reference colours in its centre area, for example, there may be white, black and grey areas arranged in the centre area of a QR code and in other part of the code there may be information about the colours in centre area.

The various embodiments of the present disclosure can be implemented with the help of computer program code that resides in a memory and causes a camera system to carry out the disclosed embodiments. For example, the camera system comprises a computing device, for example, a data processing device that may comprise circuitry and electronics for analysing, receiving and transmitting data, and configuring at least one camera of the camera system, a computer program code in a memory, and a processor which, when running the computer program code, causes the apparatus to carry out the features of an embodiment. The processor, when running the computer program code, may carry out the steps of the following method: capturing image data by at least one camera of a camera system comprising also a data processing device that is an integrated part of at least one camera or a separate device, analysing image data by the data processing device in order to detect a machine readable code, configuring at least one camera on the basis of data read from the detected machine readable code. After configuration, the camera system continues capturing and analysing the image data as defined in the machine readable code i.e. determining monitoring conditions by the machine readable code. And if the conditions are determined to be fulfilled, the camera system continues capturing and analysing image data of the environment/space. And if the conditions are analysed to be non-fulfilled, the camera system may perform an alarm or indicate user or perform any other actions, determined by the detected and read machine readable code.

Considerable advantages are achieved by the present disclosure when compared to methods and systems of existing camera systems comprising at least one camera suitable for monitoring environment. By means of the arrangement according to embodiments of the disclosure it is possible to configure the at least one camera for performing different tasks by a machine readable code(s), when needed. In addition, by means of the arrangement according to embodiments of the present disclosure, it is also possible to provide information to the camera system when needed, for example, when monitoring conditions or contact information of a user changes.

It is obvious that the present disclosure is not limited solely to the above-presented embodiments, but it can be modified within the scope of the appended claims.

1-11. (canceled)

12. A method of using a machine-readable code for configuring camera for detecting and monitoring objects, comprising:
capturing image data by at least one camera of a camera system in a space;
analysing the image data;
detecting a machine readable code comprising configuration data from the image data; and
configuring the camera system on the basis of the configuration data of the machine readable code, wherein the configuration data comprises monitoring conditions, and that the camera system is configured to perform at least one of the following analysing tasks:
determine whether a number of machine-readable codes in the image data is allowable according to the monitoring conditions,
determine whether a distance between machine readable codes or objects in the image data is allowable according to the monitoring conditions,
determine whether a distance of an object from a certain point in the image data is allowable according to the monitoring conditions,
determine whether an angle of a movement of an object in the image data is allowable according to the monitoring conditions,
determine whether a range of a movement of an object in the image data is allowable according to the monitoring conditions, or
determine whether a moving direction of an object in the image data is allowable according to the monitoring conditions.

13. The method according to claim 12, wherein the method further comprises notifying a user if at least one of the monitoring conditions is not fulfilled.

14. The method according to claim 12, wherein the method further comprises notifying a user if at least one of the monitoring conditions is fulfilled.

15. The method according to claim 12, wherein the machine-readable code comprises a contacting address where to notify when at least one of the monitoring conditions is fulfilled or is not fulfilled.

16. The method according to claim 12, wherein the machine-readable code further indicates for the camera system that there is at least one other machine-readable code in a space to be detected.

17. The method according to claim 12, wherein the machine-readable code further indicates for the camera system which at least one camera is configured to be used for monitoring the space.

18. The method according to claim 12, wherein the machine-readable code further indicates for the camera system a verification period defining a time period during which at least one of the monitoring conditions have to be fulfilled.

19. The method according to claim 12, wherein the machine-readable code is a quick response (QR) code.

20. A camera system comprising at least one camera and a data processing device, wherein at least one camera is configured to capture image data by the at least one camera; analyse the image data, detect a machine readable code comprising configuration data from the image data; and configure the camera system on the basis of the configuration data of the machine readable code, wherein the configuration data comprises monitoring conditions, and that the camera system is configured to perform at least one of the following analysing tasks:
determine whether a number of machine-readable codes in the image data is allowable according to the monitoring conditions,
determine whether a distance between machine readable codes or objects in the image data is allowable according to the monitoring conditions,
determine whether a distance of an object from a certain point in the image data is allowable according to the monitoring conditions,
determine whether an angle of a movement of an object in the image data is allowable according to the monitoring conditions,
determine whether a range of a movement of an object in the image data is allowable according to the monitoring conditions, or
determine whether a moving direction of an object in the image data is allowable according to the monitoring conditions.

21. The camera system according to claim 20, wherein the machine readable code further comprises instructions for notifying a user if at least one of the monitoring conditions is not fulfilled.

22. The camera system according to claim 20, wherein the machine readable code further comprises instructions for notifying a user if at least one of the monitoring conditions is fulfilled.

23. The camera system according to claim 20, wherein the machine readable code comprises a contacting address where to notify when at least one of the monitoring conditions is fulfilled.

24. The camera system according to claim 20, wherein the machine readable code comprises a contacting address where to notify when at least of the monitoring conditions is not fulfilled.

25. The camera system according to claim 20, wherein the machine readable code comprises information that there is at least one other machine readable code in a space to be detected.

26. The camera system according to claim 20, wherein the machine readable code comprises information about which at least one camera is configured to be used for monitoring the space.

27. The camera system according to claim 20, wherein the machine readable code comprises a verification period defining a time period during which at least one of the monitoring conditions has to be fulfilled.

28. The camera system according to claim 20, wherein the machine readable code is a quick response (QR) code.

29. A computer program product, stored on a non-transitory computer readable medium and executable in a computing device, wherein the computer program product comprises instructions for a data processing device to:
analyse image data captured by at least one camera of a camera system;
detect a machine readable code comprising configuration data from the image data; and configure the camera system on the basis of the configuration data of the machine readable code,
wherein the configuration data comprises monitoring conditions, and that the configuration data comprises instructions to perform at least one of the following analysing tasks:
determine whether a number of machine-readable codes in the image data is allowable according to the monitoring conditions;
determine whether a distance between machine readable codes or objects in the image data is allowable according to the monitoring conditions,
determine whether a distance of an object from a certain point in the image data is allowable according to the monitoring conditions,
determine whether an angle of a movement of an object in the image data is allowable according to the monitoring conditions,
determine whether a range of a movement of an object in the image data is allowable according to the monitoring conditions, or
determine whether a moving direction of an object in the image data is allowable according to the monitoring conditions.
